(19) United States
(12) Patent Application Publication
(10) Pub. No.: US 2026/0346949 A1
(43) Pub. Date: Nov. 5, 2026

(54) PROPULSION ASSEMBLY FOR MICROMOBILITY DEVICE

(71) Applicant: Also, Inc., Palo Alto, CA (US)

(72) Inventor: Arth Nireshkumar Patel, San Jose, CA (US)

(73) Assignee: Also, Inc., Palo Alto, CA (US)

(21) Appl. No.: 19/665,554

(22) Filed: May 1, 2026

Related U.S. Application Data
(60) Provisional application No. 63/798,750, filed on May 2, 2025.

(51) Int. Cl. B62M 6/50; B62J 11/10; B62J 45/20; B62J 45/413; B62J 45/422; B62M 6/90

(52) U.S. Cl. CPC B62M 6/50; B62J 11/10; B62J 45/413; B62J 45/422; B62J 45/20; B62M 6/90

(57) ABSTRACT

A micromobility device can include a frame to support the micromobility device. The micromobility device can include an assembly. The assembly can include a housing, a first element, a second element, and a circuit board. The housing can couple with the frame. The first element can be rotatably coupled with the housing. The second element can be rotatably coupled with the housing. The circuit board can be disposed at least partially between the first element and the second element. The circuit board can include a first sensor and a second sensor. The first sensor can detect rotation of the first element. The second sensor can detect rotation of the second element. The circuit board can output, based at least on detection of the rotation of the first element or the rotation of the second element, a control signal to control a characteristic of the micromobility device.

### CROSS-REFERENCE TO RELATED PATENT APPLICATIONS

This application claims the benefit of and priority to U.S. Provisional Patent Application No. 63/798,750, filed May 2, 2025, the entirety of which is incorporated by reference herein, for all purposes.

### BACKGROUND

Micromobility devices, such as electric bicycles, can include drive mechanisms to propel the micromobility devices.

### SUMMARY

This disclosure is generally related to one or more components of a micromobility device, such as a bicycle. The components can include at least one of assemblies, sub-assemblies, modules, systems, platforms, or components. For example, the bicycle can include an assembly having one or more housings to facilitate control of the bicycle. As another example, the assembly can include a circuit board having one or more processors, coupled with memory, to detect movement of the housings.

At least one aspect is directed to a micromobility device. The micromobility device can include a frame. The frame can support the micromobility device. The micromobility device can include an assembly. The assembly can include a housing. The housing can couple with the frame. The assembly can include a first element. The first element can be rotatably coupled with the housing. The assembly can include a second element. The second element can be rotatably coupled with the housing. The assembly can include a circuit board. The circuit board can be disposed at least partially between the first element and the second element. The circuit board can include a first sensor. The first sensor can detect rotation of the first element. The circuit board can include a second sensor. The second sensor can detect rotation of the second element. The circuit board can output, based at least on detection of the rotation of the first element or the rotation of the second element, a control signal to control a characteristic of the micromobility device.

At least one aspect is directed to an assembly. The assembly can include a first housing. The first housing can be coupled with a frame of a micromobility device. The first housing can receive one or more first inputs to control a rate of speed of the micromobility device. The assembly can include a second housing. The second housing can be coupled with the first housing. The second housing can receive one or more second inputs to indicate an amount of assistance provided by a drive mechanism of the micromobility device. The assembly can include a circuit board. The circuit board can be disposed at least partially between the first housing and the second housing. The circuit board can include at least one sensor. The at least one sensor can detect movement of the first housing and movement of the second housing.

At least one aspect is directed to a system. The system can include an assembly. The assembly can include a first housing. The first housing can be coupled with a frame of a micromobility device. The first housing can receive one or more first inputs to control a rate of speed of the micromobility device. The assembly can include a second housing. The second housing can be coupled with the first housing. The second housing can receive one or more second inputs to indicate an amount of assistance provided by a drive mechanism of the micromobility device. The assembly can include a circuit board. The circuit board can be disposed at least partially between the first housing and the second housing. The circuit board can include at least one sensor. The at least one sensor can detect movement of the first housing and movement of the second housing.

At least one aspect is directed to an assembly. The assembly can include a first housing. The first housing can couple with at least a first portion of a handlebar of a bicycle. The first housing can receive one or more first inputs to control a rate of speed of the bicycle. The assembly can include a second housing. The second housing can couple with the first housing. The second housing can receive one or more second inputs to indicate an amount of assistance provided by a drive mechanism of the bicycle. The assembly can include a circuit board. The circuit board can be disposed at least partially between the first housing and the second housing. The circuit board can include at least one sensor. The at least one sensor can detect movement of the first housing and movement of the second housing.

At least one aspect is directed to a bicycle. The bicycle can include a handlebar. The handlebar can couple with a frame of the bicycle. The bicycle can include an assembly. The assembly can include a first housing. The first housing can couple with at least a first portion of the handlebar. The first housing can receive one or more first inputs to control a rate of speed of the bicycle. The assembly can include a second housing. The second housing can couple with the first housing. The second housing can receive one or more second inputs to indicate an amount of assistance provided by a drive mechanism of the bicycle. The assembly can include a circuit board. The circuit board can be disposed at least partially between the first housing and the second housing. The circuit board can include at least one sensor. The at least one sensor can detect movement of the first housing and movement of the second housing.

At least one aspect is directed to a system. The system can include a first housing. The first housing can be included in an assembly. The first housing can couple with at least a first portion of a handlebar of a bicycle. The first housing can receive one or more first inputs to control a rate of speed of the bicycle. The system can include a second housing. The second housing can couple with the first housing. The second housing can receive one or more second inputs to indicate an amount of assistance provided by a drive mechanism of the bicycle. The system can include a circuit board. The circuit board can be disposed at least partially between the first housing and the second housing. The circuit board can detect, via at least one sensor, movement of the first housing and movement of the second housing.

At least one aspect is directed to a method. The method can include coupling a first housing of an assembly with at least a first portion of a handlebar of a bicycle. The first housing can receive one or more first inputs to control a rate of speed of the bicycle. The method can include coupling a second housing of the assembly with the first housing. The second housing can receive one or more second inputs to indicate an amount of assistance provided by a drive mechanism of the bicycle. The method can include disposing a circuit board of the assembly at least partially between the first housing and the second housing. The circuit board can include at least one sensor. The at least one sensor can detect movement of the first housing and movement of the second housing.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a micromobility device, in accordance with some aspects.

FIG. 2 depicts the micromobility device of FIG. 1, in accordance with some aspects.

FIG. 3 depicts a perspective view of an assembly coupled with a handle of the micromobility device of FIG. 2, in accordance with some aspects.

FIG. 4 depicts a perspective view of a throttle sub-assembly included in the assembly of FIG. 3, in accordance with some aspects.

FIG. 5A depicts a perspective view of the throttle sub-assembly of FIG. 4, in accordance with some aspects.

FIG. 5B depicts a perspective view of the throttle sub-assembly of FIG. 4, in accordance with some aspects.

FIG. 6 depicts a perspective view of a toggle sub-assembly included in the assembly of FIG. 3, in accordance with some aspects.

FIG. 7A depicts a perspective view of the toggle sub-assembly of FIG. 6, in accordance with some aspects.

FIG. 7B depicts a perspective view of the toggle sub-assembly of FIG. 6, in accordance with some aspects.

FIG. 8 depicts a perspective view of a first side of a circuit board included in the assembly of FIG. 3, in accordance with some aspects.

FIG. 9 depicts a perspective view of a second side of the circuit board included in the assembly of FIG. 3, in accordance with some aspects.

FIG. 10 depicts a perspective view of the second side of the circuit board included in the assembly of FIG. 3, in accordance with some aspects.

FIG. 11A depicts a perspective view of the throttle sub-assembly and the toggle sub-assembly included in the assembly of FIG. 3, in accordance with some aspects.

FIG. 11B depicts a perspective view of the throttle sub-assembly and the toggle sub-assembly included in the assembly of FIG. 3, in accordance with some aspects.

FIG. 12 is a flow diagram of a process to manufacture at least one assembly, in accordance with aspects.

FIG. 13 is a block diagram illustrating an architecture for a computer system that can be employed to implement elements of the systems and methods described and illustrated herein.

### DETAILED DESCRIPTION

Following below are more detailed descriptions of various concepts related to and implementations of methods, apparatuses, and systems of one or more assemblies for a micromobility device. The various concepts introduced above and discussed in greater detail below may be implemented in any of numerous ways.

The present disclosure is directed to one or more components for a micromobility device, such as a bicycle, quad, or e-bike, among other vehicles as described herein. The components can include one or more assemblies, systems, modules, elements, or components. For example, the bicycle can include a first housing and a second housing for example as part of an overall handlebar assembly. The first housing and the second housing can move, swivel, or otherwise rotate relative to one another to receive inputs to control subsequent operation of the bicycle. For example, the first housing or the second housing can rotate to receive an input that triggers a generation or a transmission of control signals that control one or more characteristics of a bike, such as a rate of speed or an amount of assistance. As another example, the movement (of the first housing or the second housing) can be detected by one or more sensors which triggers generation or transmission of the control signals. In some instances, bikes with a series hybrid configuration can provide a multitude of ride customizations or ride alterations, such as speed adjustment, pedal resistance, manual propulsion assistance, among other possible alterations to enhance the user experience.

Some technical solutions described herein have a technical advantage of providing an assembly with one or more integrated components. For example, the assembly can integrate at least one housing with a circuit board to improve input detection. As another example, the assembly can be provided as an integrated system which includes components to control or adjust operation of a bicycle. The assembly can include a first housing to facilitate receipt of inputs with respect to a speed of the bicycle and a second housing to facilitate receipt of inputs with respect to an amount of assistance provided by a drive mechanism or an amount of resistance experienced at the pedals. The circuit board can house or otherwise include at least one sensor to detect movement of the first housing or the second housing.

The co-location or positioning of the first housing in close proximity to the second housing provides a technical advantage as each housing can be interfaced with or actuated by a single digit (e.g., a finger) of the operator of the bike. In bikes with a series hybrid configuration, the assembly described herein provides a technical advantage in that fine-tuned propulsion control (e.g., speed control, assistance control) can be provided at a single location of the bike. For instance, the assembly provides intuitive and ease of access (from a single point on the bike) for multiple control elements of the bike which enhance the user experience of the series hybrid configuration bike.

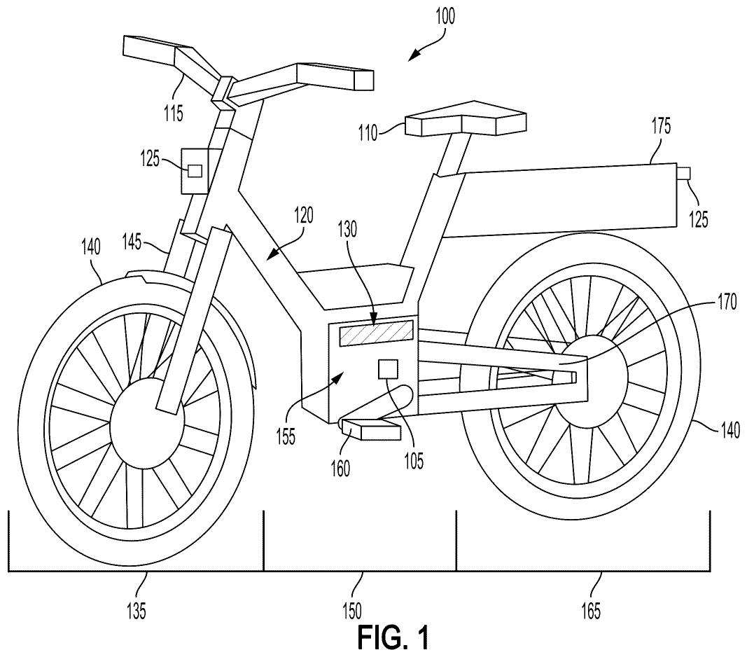

FIG. 1 depicts an example perspective view of a micromobility device, such as a bicycle (referred to generally herein as bike 100, which is understood to include a reference to any micromobility device). The bike 100 can be an electric bike installed with at least one battery pack 105. The bike 100 can include at least one bicycle. The bike 100 can be a human-operated bike. The bike 100 can include single rider bicycles, tandem bicycles, cargo bicycles, motor-assist bicycles, pedicabs, electric-assist bicycles, roadway bicycles, mountain bicycles, or unicycles, among others. The battery pack 105 can also be used as an energy storage system to power a building, such as a residential home or commercial building. The bike 100 can be fully electric or partially electric (e.g., pedal-powered) and further, the bike 100 can be fully autonomous, partially autonomous, semi-autonomous, or unmanned. The bike 100 can also be human operated or non-autonomous.

A human operator or rider of the bike 100 can sit on a seat 110 to operate the bike 100. The rider of the bike 100 can steer, grip, balance, or otherwise control the bike 100 using handlebar 115. The rider or operator of the bike 100, for which the seat 110 can support, can refer to or include a primary occupant of the bike 100.

The bike 100 can include a frame 120. The frame 120 can support various components of the bike 100, such as the handlebar 115, the seat 110, the battery pack 105, at least one light 125, and at least one lock assembly 130. The frame 120 can span a front portion 135. The front portion 135 can support, be coupled with, or include, for example, a wheel 140 of the bike 100, a fork 145 of the bike 100, the handlebar 115, the light 125, among other components. The bike 100 can include two or more wheels 140 (e.g., a front wheel 140 and a rear wheel 140).

The frame 120 can span a middle portion 150. The middle portion 150 can support, be coupled with, or include, for example, the seat 110, the battery pack 105, a crank shaft or drive mechanism (shown as drive mechanism 155) of the bike 100, or a pedal 160 of the bike 100, among other components. The frame 120 can include the middle portion 150 including the lock assembly 130. The frame 120 can include a rear portion 165. The rear portion 165 can support, be coupled with, or include, for example, a rear wheel 140 of the bike 100, the light 125, a drivetrain 170 of the bike 100, a rack assembly 175 of the bike 100, or among other components. The battery pack 105 can be disposed anywhere within the frame 120.

The battery pack 105 can include at least one battery, at least one battery module, or at least one battery cell. The battery pack 105 can be electrically coupled with the bike 100 (e.g., to the drive mechanism 155, to the light 125, the lock assembly 130, or some other components). For example, the battery pack 105 can provide electrical energy to the bike 100 to power the bike 100.

The battery pack 105 can be installed or placed within the bike 100. For example, the battery pack 105 can be installed on the frame 120 of the bike 100 within one or more of the front portion 135, the middle portion 150, or the rear portion 165. The battery pack 105 can be integrally coupled with the frame 120 such that it is not removable. The battery pack 105 can be detachably coupled with the frame 120 such that the battery pack 105 can be removed (e.g., to charge the battery pack 105).

The battery pack 105 can include or connect with at least one busbar, e.g., a current collector element. For example, the busbar can include electrically conductive material to connect or otherwise electrically couple the battery pack 105 with other electrical components of the bike 100 to provide electrical power to various systems or components of the bike 100, such as the lock assembly 130 or some other system.

The bike 100 can include the lock assembly 130 electrically coupled with the battery pack 105. For example, the battery pack 105 can be electrically coupled with a receiver of the lock assembly 130 to facilitate the actuation or movement of one or more components of the receiver. In this way, the receiver can be configured to be controlled or actuated electronically via power provided by the battery pack 105, rather than being controlled or actuated manually or mechanically (e.g., via some manual action of an operator of the bike 100). The battery pack 105 can provide power to other components of the bike 100 (e.g., the drive mechanism 155, the light 125, or some other component) simultaneously, separately, in sequence, or in some other manner.

The bike 100 can be electrically propelled or manually propelled. For example, the bike 100 can include a series hybrid propulsion system. As another example, the battery pack 105 can provide power to the drive mechanism 155 to power the drivetrain 170 to propel the bike 100 (e.g., propel the bike by causing the at least one wheel 140 to rotate). As another example, an operator of the bike 100 can operate or otherwise move the pedals 160 to manually move or power the drivetrain 170.

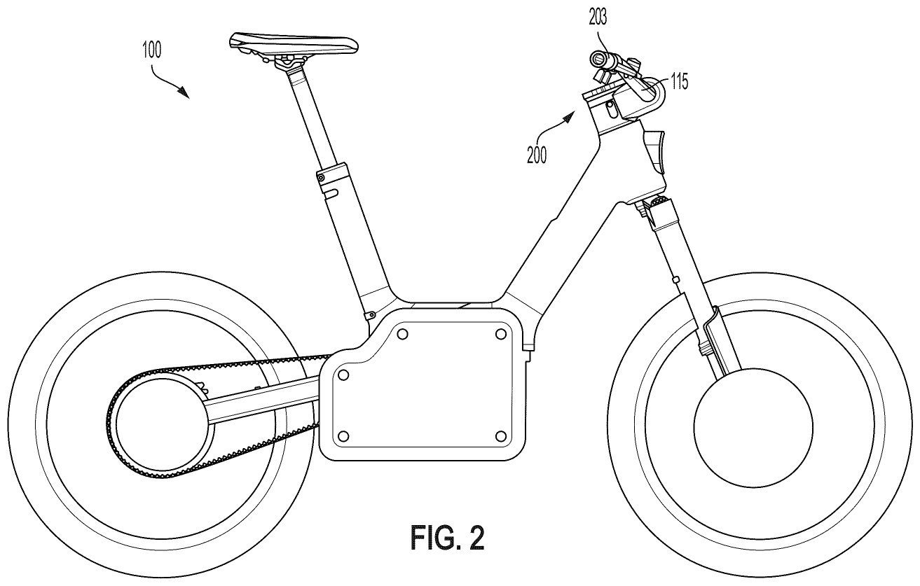

FIG. 2 depicts a view of the bike 100, in accordance with some aspects. The view of the bike 100, as shown in FIG. 2, can refer to or include a side-view. The bike 100 or one or more components thereof can include sub-components, elements, or members. For example, as shown in FIG. 2, the bike 100 includes an assembly 200. The assembly 200 can include at least one assembly or component described herein. For example, the assembly 200 can include one or more of toggles, throttles, selectors, or input devices. As another example, the assembly 200 can include at least one housing to facilitate receipt of one or more inputs to control operation of the bike 100. The inputs can refer to or include an activation, an actuation, an application of force, among of types of interactions (with the housing) that cause the housing to move.

The assembly 200 can refer to or include at least one of a system, a platform, an integrated package, a micromobility device control module, a hand control module, or an integrated control assembly. For example, the assembly 200 can include at least one system that represents or includes one or more assemblies. As another example, the assembly 200 can include a control module that is integrated with the handlebar 115. The assembly 200 can include a housing or body that is coupled with bike 100. For example, the assembly 200 can include a housing that coupled with the frame 120. The housing (of the assembly 200) can receive or otherwise accept one or more housings (or sub-housings) or elements of the assembly 200.

The assembly 200 can be located at or disposed on one or more portions or areas of the bike 100. For example, and as shown in FIG. 2, the assembly 200 is disposed on or otherwise coupled with the handlebar 115. As another example, the assembly 200 can be disposed on the frame 120. The assembly 200 can be coupled with one or more components of the bike 100. For example, the assembly 200 can be electrically coupled with the battery pack 105 such that the assembly 200 can receive electrical energy from the battery pack 105. As another example, the assembly 200 can be communicably coupled with the drivetrain 170 such that the assembly 200 can send signals to or receive signals from the drivetrain 170. As another example, the assembly 200 can be communicably coupled with a computing device or processing circuitry which controls operation of the bike 100. The assembly 200 can define a rider interface located at a hand-operable region of the bike 100 such that multiple control functions can be accessed from a common location on the bike 100. For example, the assembly 200 can include one or more housings, input members, support structures, and actuating components arranged together as a unified package.

The assembly 200 can be integrated with the handlebar 115 such that at least a portion or segment of the assembly 200 is unified with the handlebar 115. For example, a housing or other possible assembly (which defines the handlebar 115) can include at least a portion of the assembly 200 (e.g., the assembly 200 is included in, disposed within, or integrated with a housing of the handlebar 115). As another example, the assembly 200 can be integrated with at least one handle (shown as handle 203) of the handlebars 115. The assembly 200 can be integrated with the handle 203 by at least one of coupling, attaching, securing, or otherwise mounting the assembly 200 to the handle 203. For example, the assembly 200 can include at least one recess or opening such that the handle 203 can pass through or otherwise navigate through the opening of the assembly 200.

The handle 203 can provide at least one surface or area for which the assembly 200 can couple with. For example, the handle 203 can provide a base for which the assembly 200 can be mounted to. As another example, the handle 203 can provide a support structure to provide rigidity to support a placement of the assembly 200. The handle 203 can couple with one or more portions, segments, or elements of the assembly 200. For example, the handle 203 can couple with one or more sub-assemblies of the assembly 200.

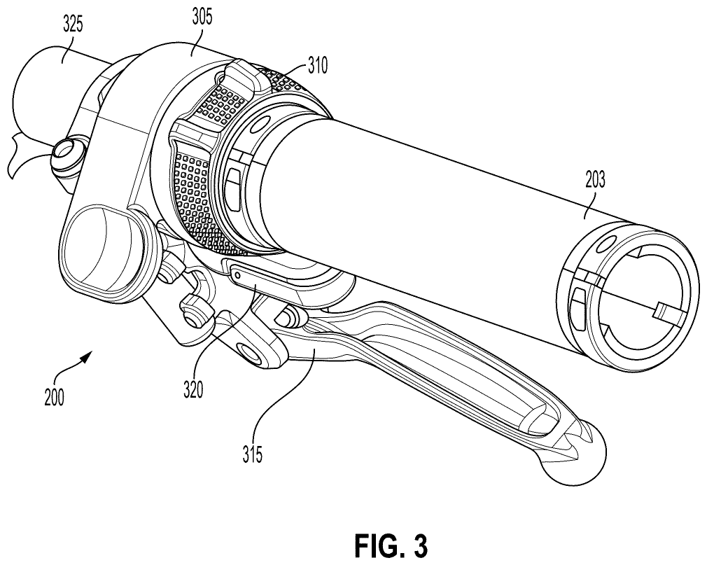

FIG. 3 depicts a perspective view of the assembly 200, in accordance with some aspects. The assembly 200 can be included with or coupled with the handlebar 115 via the handle 203. For example, and as shown in FIG. 3, the assembly 200 is coupled with the bike 100 via the handle 203. The handle 203 can be inserted through or otherwise traverse a void or cavity defined by one or more sub-assemblies of the assembly 200 such that the handle 203 can couple with a frame (e.g., the frame 120) or structural member of the bike 100. The assembly 200 can define a control interface or a control module to facilitate control of one or more functions or operations of the bike 100. For example, the assembly 200 can be disposed or otherwise located at a hand-operable region of the handle 203 or the handlebar 215, such that the assembly 200 is accessible while a rider operates or otherwise utilizes the bike 100 (e.g., rides).

The assembly 200 can receive one or more inputs to facilitate control or operation of the bike 100. For example, the assembly 200 can receive one or more inputs to control a speed of the bike 100. As another example, the assembly 200 can receive one or more inputs to adjust an amount of assistance provided by the drive mechanism 155 during manual propulsion (e.g., pedaling) of the bike 100 or an amount of resistance experienced at the pedals 160 by a user. The assembly 200 or one or more components thereof can twist, rotate, spin, or otherwise move to receive inputs to control operation of the bike 100. For example, the assembly 200 or one or more elements thereof can be rotatably coupled with the bike 100 such that elements move independent of the bike 100 or separate from the bike 100.

The assembly 200 can include one or more assemblies, sub-assemblies, housings, input elements, linkages, support portions, and actuation features arranged together as a unified package. For example, and as shown in FIG. 3, the assembly 200 includes a throttle sub-assembly 305, a toggle sub-assembly 310, a brake sub-assembly 315, and a turn-signal sub-assembly 320. The sub-assemblies of the assembly 200 can be coupled with or otherwise secured to the handle 203. For example, the throttle sub-assembly 305 can be coupled with a first portion of the handle 203.

The throttle sub-assembly 305 can be coupled with the handle 203 via one or more fasteners. For example, the throttle sub-assembly 305 can be secured to the handle 203 via at least one hose clamp. The throttle sub-assembly 305 and the toggle sub-assembly 310 can include or house one or more components to facilitate control of the bike 100. For example, each of the throttle sub-assembly 305 and the toggle sub-assembly 310 can include respective housings or bodies that rotate or otherwise move about an axis to receive at least one input. As another example, at least one of the throttle sub-assembly 305 or the toggle sub-assembly 310 can include input elements (e.g., buttons, toggles, switches) to receive at least one input.

The throttle sub-assembly 305 can include a body and a thumb pad that are accessible to a rider of the bike 100. For example, the thumb pad can be accessible (by the rider) while the rider sits or rests on the seat 110. The toggle sub-assembly 310 can include a ring-like or collar-like body (with one or more raised or elevated elements) positioned adjacent to the throttle sub-assembly 305. The brake sub-assembly 315 can include a brake lever and a mounting portion.

The brake sub-assembly 315 can be positioned below or offset from the handle 203 such that a lever (of the brake sub-assembly 315) extends parallel with the handle 203 and can be drawn inward toward the handle 203 by the rider.

The turn-signal sub-assembly 320 can include a movable selector, input element, or switch member to actuate (e.g., turn on, turn off) a blinker or turn-signal of the bike 100. The turn-signal sub-assembly 320 can be disposed between the handle 203 and the brake sub-assembly 315. For example, and as shown in FIG. 3, the turn-signal sub-assembly 320 is positioned in an area or region (of the assembly 200) that is at least partially between the toggle sub-assembly 310 and the brake sub-assembly 315.

The throttle sub-assembly 305 and the toggle sub-assembly 310 can be positioned adjacent one another along the handle 203. For example, the throttle sub-assembly 305 and the toggle sub-assembly 310 can be position side by side or otherwise is a left to right arrangement. The throttle sub-assembly 305 and the toggle sub-assembly 310 can be arranged around the handle 203 in a nested or stacked manner. For example, each of the throttle sub-assembly 305 and the toggle sub-assembly 310 can define a respective void, opening, or cavity through which a protrusion or elongated member (shown as elongated member 325) of the handle 203 can extend through or otherwise traverse to couple the handle 203 with the handlebars 115. The void or cavities (of the throttle sub-assembly 305 and the toggle sub-assembly 310) can encircle or otherwise surround the elongated member 325. The toggle sub-assembly 310 can be positioned between the throttle sub-assembly 305 and a surface (e.g., a region or portion) of the handle 203 that receives a hand of the rider of the bike 100.

The throttle sub-assembly 305 can receive a rider input (e.g., a first input) to control acceleration (e.g., a rate of speed) of the bike 100. For example, the thumb pad of the throttle sub-assembly 305 can be depressed or otherwise actuated (by the rider) to bring about movement of the body (of the throttle sub-assembly 305) to receive the first input. The movement of the body (of the throttle sub-assembly 305) can be response to an application of force (by the rider) to the thumb pad. As another example, the thumb pad can pivot, rotate, depress, or otherwise displace from a rest position to an actuated position. The movement (of the throttle sub-assembly 305) can be transferred to an internal linkage or switch so that a corresponding throttle command (e.g., control signal) is generated by a processing circuit of the bike 100. The movement (of the throttle sub-assembly 305) can result in movement of one or more magnets (disposed within the throttle sub-assembly 305) which trigger detection (of the overall movement) by one or more sensors. The detection (by the sensors) of the movement can result in generation of the throttle command. The throttle command can be provided to a motor controller or the drive mechanism 155 to increase or otherwise adjust propulsion of the bike 100. The magnitude of movement of the thumb pad (or the throttle sub-assembly 305) can correspond to a magnitude of the throttle command.

The rotation or movement of the throttle sub-assembly 305 can be detected via one or more of an optical encoder, an accelerometer, a gyroscope, or other types of sensors. For example, the assembly 200 can include an optical encoder that can detect movement or rotation of the throttle sub-assembly 305. The throttle sub-assembly 305 can be biased or spring loaded such that (upon release, deactivation, or letting go of the throttle sub-assembly 305) the throttle sub-assembly 305 automatically returns to a default or starting position.

The toggle sub-assembly 310 can receive a ride input (e.g., a second input) to adjust an amount of assistance provided to the rider. For example, the toggle sub-assembly 310 can include a movable portion or housing that rotates, pivots, toggles, or shifts relative to handle 203 to receive the second input. A rider can engage the toggle sub-assembly 310 to move (the toggle sub-assembly 310) in a first direction. Movement of the toggle sub-assembly 310 can result in an increase or a decrease in an amount of assistance that is provided (by the drive mechanism 155 or the drivetrain 170) during manual propulsion of the bike 100. The movement of the toggle sub-assembly 310 can result in an increase or a decrease in an amount of resistance that is applied (by the series hybrid system of the bike 100) to the pedals 160, such that operator of the bike 100 may need to alter how much force is applied (to the pedals 160) to rotate the pedals 160.

The movement of the toggle sub-assembly 310 can correspond to discrete, indexed positions associated with respective assistance levels. For example, movement of the toggle sub-assembly 310 can actuate one or more switches, contacts, or sensors to generate a control signal indicative of a selected assistance setting. As another example, movement of the toggle sub-assembly 310 can displace or otherwise adjust an internal position of one or more magnets, which trigger detection of the overall movement by one or more sensors. A processing circuit (of the bike 100) can generate a control signal to adjust a pedal-assist mode, a power-assist magnitude, or other rider-support parameter of the bike 100. The rotation or movement of the toggle sub-assembly 310 can be detected via one or more of an optical encoder, an accelerometer, a gyroscope, or other types of sensors. For example, the assembly 200 can include an optical encoder that can detect movement or rotation of the toggle sub-assembly 310. The movement or rotation of the toggle sub-assembly 310 can be detected via non-magnetized ferrous material or optical marks. For example, the assembly 200 can include a sensor that can detect movement of the ferrous material (which can be interpreted as corresponding to movement of the toggle sub-assembly 310). The toggle sub-assembly 310 can be biased or spring loaded such that (upon release, deactivation, or letting go of the toggle sub-assembly 310) the toggle sub-assembly 310 automatically returns to a default or starting position.

The arrangement of the toggle sub-assembly 310 adjacent to the throttle sub-assembly 305 can permit assistance adjustment without substantial repositioning of the hand of the rider. For example, the toggle sub-assembly 310 is positioned in close proximity to the throttle sub-assembly 305 such that either of the toggle sub-assembly 310 or the throttle sub-assembly 305 is accessible without substantial repositioning of the hand of the rider. As another example, the toggle sub-assembly 310 can be co-located or in close proximity to the throttle sub-assembly 305 such that either of the toggle sub-assembly 310 or the throttle sub-assembly 305 is interfaceable with a single digit (e.g., a finger) of the operator of the bike 100.

The brake sub-assembly 315 can receive a rider input to slow or stop the bike 100. For example, the lever (of the brake sub-assembly 315) can pivot relative to a mounting portion (of the brake sub-assembly 315) in response to a pulling force applied by the rider of the bike 100. As another example, the lever can move from an outward rest position to an actuated position, thereby tensioning a cable, actuating a hydraulic mechanism, triggering a brake sensor, or otherwise initiating braking of the bike 100.

The turn-signal sub-assembly 320 can receive an input to activate or deactivate a blinker or turn signal of the bike 100. For example, the turn-signal sub-assembly 320 can include a switch member that pivots, slides, rocks, or otherwise moves relative to a support portion (of the turn-signal sub-assembly 320). The rider can move the turn-signal sub-assembly 320 in a first direction to indicate one turn direction and in a second direction to indicate an opposite turn direction. Such movement can actuate one or more electrical contacts or sensors to generate a signaling command for a lighting or signaling system of the bike 100. The location of the turn-signal sub-assembly 320, between the handle 203 and the brake sub-assembly 315, can facilitate access to the signaling function while preserving separate access to the throttle sub-assembly 305, the toggle sub-assembly 310, and the brake sub-assembly 315.

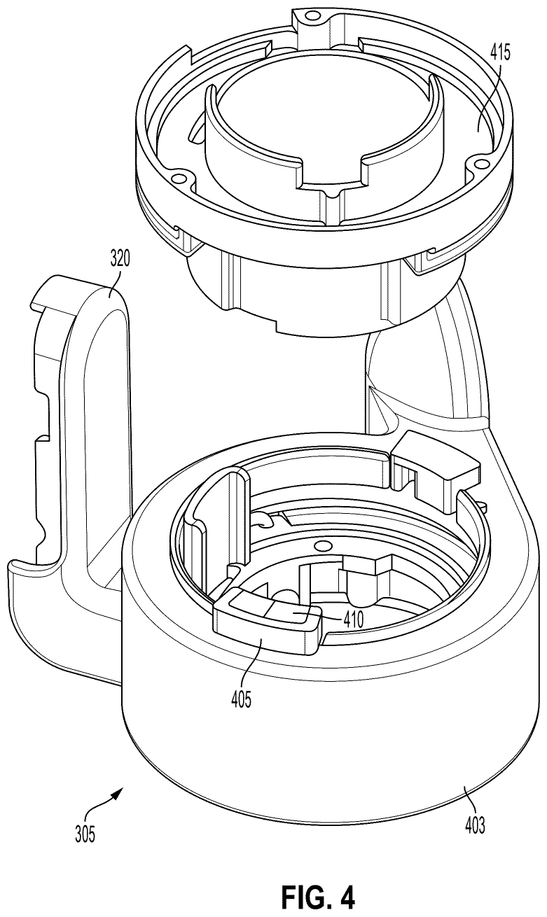

FIG. 4 depicts a perspective view of the throttle sub-assembly 305, in accordance with some aspects. The perspective view of the throttle sub-assembly 305, as shown in FIG. 4, can refer to or include an expanded view to show one or more components (of the throttle sub-assembly 305) separated from one another. While the throttle sub-assembly 305 is shown (in FIG. 4) with certain components separated in an upward and downward direction, this depiction is for clarity purposes only and is in no way limiting. For example, the throttle sub-assembly 305 can be arranged along a left-to-right orientation when installed on the bike 100.

The throttle sub-assembly 305 can include at least one first housing (shown as throttle housing 403) to receive or otherwise accept one or more components. For example, the throttle housing 403 can receive components of the throttle sub-assembly 305. The throttle housing 403 can refer to or include at least one of a twist throttle or a lever operated throttle. The throttle housing 403 can refer to or include a first element that is rotatably coupled with a portion of the assembly, such as a housing of the assembly 200. The throttle housing 403 can define or otherwise include a body that provides a shape or dimension of the throttle sub-assembly 305. The throttle housing 403 can receive one or more inputs to control operation of the bike 100. For example, the throttle housing 403 can rotate or otherwise move about an axis to receive inputs to control a speed of the bike 100. Rotation or movement of the throttle housing 403 can occur responsive to or based on a depression or actuation of a thumb pad of the throttle sub-assembly 305.

The throttle housing 403 can receive inputs to control a rate of speed of the bike 100. For example, an operator of the bike 100 can rotate or otherwise move the throttle housing 403 by a given amount to provide an indication of a speed for the bike 100. The movement of the throttle housing 403 can cause the drivetrain 170 or the drive mechanism 155 to provide an amount of force that results in the bike 100 moving at a rate of speed that corresponds to the movement of the throttle housing 403. For example, movement of the throttle housing 430 can trigger or cause one or more control signals to be transmitted to one or more components of the bike 100. The control signals can cause a production of an amount of force or power such that the bike 100 moves or is otherwise propelled. For example, the control signals can control a characteristic of the bike 100, such as the rate of speed of the bike 100, an amount of assistance provided by the drive mechanism 155, or an amount of torque that is needed to rotate the pedals 160.

The throttle housing 403 can include at least one recess. For example, as shown in FIG. 4, the throttle housing 403 includes a first recess 405. The first recess 405 can accommodate or otherwise accept at least one first magnet 410. For example, the first magnet 410 can be placed in or otherwise located in the first recess 405. The first recess 405 can refer to or include at least one of a cavity or indentation for which the first magnet 410 can be located. The first magnet 410 can be secured to the first recess 405 such that the first magnet 410 moves or rotates in conjunction with movement or rotation of the throttle housing 403. The first recess 405 can define or otherwise establish a position or location of the first magnet 410 with respect to the throttle housing 403. For example, the first recess 405 can define a known or predetermined location for the first magnet 410.

The throttle sub-assembly 305 can include at least one receiver 415. The receiver 415 can couple with or otherwise attach to the throttle housing 403. For example, the receiver 415 can be coupled with the throttle housing 403 via one or more fasteners. The receiver 415 can provide or otherwise define an area for which at least one piece of a circuit or circuitry can be located. For example, the receiver 415 can provide a surface for which a circuit board, a printed circuit board, or among other possible types of circuitry can be located. As another example, the receiver 415 can facilitate electrical and mechanical connectivity between the circuit board and the throttle housing 403. The receiver 415 can include connectors or mountings points for which one or more components can be coupled with or otherwise connected to.

The throttle housing 403 can move separate from, relative to, or with respect to the receiver 415. For example, a relative position of the receiver 415 can be maintained even as the throttle housing 403 moves or otherwise rotates. As another example, a position, a placement, or a location (within space) of the receiver 415 can be fixed or otherwise maintained while the throttle housing 403 moves about or relative to the receiver 415. The receiver 415 can be coupled or otherwise secured to the handle 203. For example, the receiver 415 can be fixably coupled with the handle 203 via one or more fasteners. The position or location of the receiver 415 can provide or represent a known or base position (as the receiver 415 may be fixably coupled with the handle 203) for which changes in position of one or more components (of the assembly 200) can be compared to. For example, given that the position of the receiver 415 is maintained (e.g., stable, unchanged, consistent, etc.), one or more changes in position of the throttle housing 403 can be detected through comparison to the position of the receiver 415 or one or more components coupled with the receiver 415 (e.g., the circuit board, one or more sensors, etc.). As another example, the relative position of the receiver 415 can represent a base or starting position for which all changes in position (of the throttle housing 403) are compared with to determine magnitude of the movement.

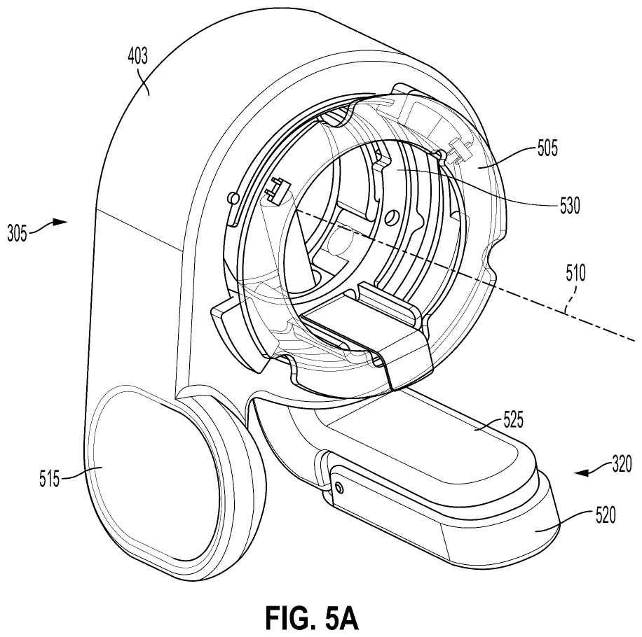

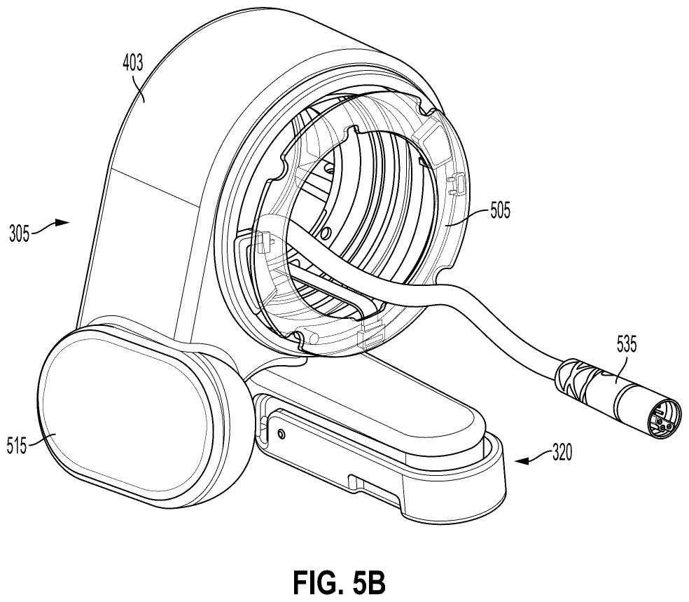

FIG. 5A and FIG. 5B depict perspectives view of the throttle sub-assembly 305, according to some aspects. For example, the perspective views can refer to or include a view of the throttle sub-assembly 305 separated from or otherwise decoupled from the toggle sub-assembly 310. The assembly 200 can include at least one circuit board 505. The circuit board 505 can couple with one or more components of the assembly 200. For example, the circuit board 505 can electrically couple with the throttle sub-assembly 305. As another example, the circuit board 505 can be fixably coupled with the receiver 415. The circuit board 505 can refer to or include one or more of printed circuit boards, solderless boards, conductive substrates, matrix boards, wire wrapped boards, or among other types of boards to receive or house circuitry components.

The circuit board 505 can be disposed or otherwise located within the assembly 200. For example, the circuit board 505 can be disposed at least partially between the throttle sub-assembly 305 and the toggle sub-assembly 310. The circuit board 505 can be disposed, placed, located, or otherwise positioned within the assembly 200 during assembly, production, or manufacturing of the assembly 200. For example, the circuit board 505 can be disposed within the assembly 200 responsive to the throttle sub-assembly 305 having been coupled with the toggle sub-assembly 310. As another example, the circuit board 505 can be disposed within the assembly 200 responsive to the circuit board having been fixably coupled with the receiver 415.

The circuit board 505 can be internal to or otherwise enclosed by each of the throttle sub-assembly 305 and the toggle sub-assembly 310. For example, movably coupling or otherwise attaching the toggle sub-assembly 310 with the throttle sub-assembly 305 can enclose the circuit board 505. As another example, the circuit board 505 can be enclosed by the throttle sub-assembly 305 and the toggle sub-assembly 310 responsive to the handle 203 having coupled the assembly 200 with the bike 100. The enclosure of the circuit board 505 can insulate or otherwise shield the circuit board 505. For example, the circuit board 505 can be protected against dirt or debris when enclosed by the throttle sub-assembly 305 and the toggle sub-assembly 310.

The throttle housing 403 can move about at least one axis (shown as axis 510 in FIG. 5A). For example, the throttle housing 403 can rotate, spin, or swivel about the axis 510 such that the throttle housing 403 travels in a circular or semi-circular movement pattern around the axis 510. At least one additional component of the assembly 200 can move about the axis 510. For example, at least a portion of the toggle sub-assembly 310 can move about the axis 510.

The throttle housing 403 can move in one or more directions about the axis 510. For example, the throttle housing 403 can move in a clockwise direction about the axis 510. As another example, the throttle housing 403 can move in a counterclockwise direction about the axis 510. Stated otherwise the throttle housing 403 can move in one or more directions that are different, opposite, or distinguishable from one another. The throttle housing 403 can move in at least one first direction responsive to an activation or an actuation. For example, an operator of the bike 100 can interface with, contact, or otherwise maneuver the throttle housing 403 to cause the throttle housing 403 to move in the first direction.

The throttle housing 403 can move in at least one second direction responsive to a deactivation. For example, upon an operator of the bike 100 releasing or otherwise no longer actuating the throttle housing 403, the throttle housing 403 can move in the second direction. The throttle housing 403 can be spring loaded or otherwise arranged such that releasing the throttle housing 403 results in the throttle housing 403 returning to a resting position or default placement. Stated otherwise, the throttle housing 403 can automatically return to a default or resting position responsive to an operator of the bike 100 no longer interfacing with or actuating the throttle housing 403.

As shown in FIG. 5A and FIG. 5B, the throttle sub-assembly 305 includes a movable member (shown as thumb pad 515). The thumb pad 515 can refer to or include the thumb pad described herein. For example, the thumb pad 515 can be depressed or actuated to cause a resultant movement of the throttle housing 403. The resultant movement of the throttle housing 403 can trigger acceleration or an adjustment of speed for the bike 100. The thumb pad 515 can include a concave surface to accommodate for or otherwise accept at least a portion of the thumb of an operator. For example, the concave surface can create a recess or an indent for which at least a portion of the thumb can rest in while depressing the thumb pad 515.

The assembly 200 can include at least one connector or cabling to electrically couple one or more components (of the bike 100) with one another. For example, as shown in FIG. 5B, the assembly 200 includes at least one cable (shown as cabling 535). The cabling 535 can electrically couple one or more components of the assembly 200 with one or more components of the bike 100. For example, the cabling 535 can electrically couple the circuit board 505 with the light 125. As another example, the cabling 535 can electrically couple the circuit board 505 with a controller of the bike 100. The cabling 535 can span or otherwise traverse one or more sections, segments, or areas of the bike 100 or the assembly 200. For example, the cabling 535 can span from one side of the throttle sub-assembly 305, through a respective cavity of each of the throttle sub-assembly 305, the circuit board 505, and the toggle sub-assembly 310, and continue beyond a side of the throttle sub-assembly 305. The cabling 535 can extend beyond the throttle sub-assembly 305, the circuit board 505, and the toggle sub-assembly 310 to electrically couple components of the assembly 200 with components of the bike 100.

As shown in FIG. 5A, the turn-signal sub-assembly 320 includes at least one input element (shown as button 520) and at least one linkage member (shown as member 525). The button 520 can be coupled with or otherwise secured to the member 525. For example, the button 520 can be movably coupled with the member 525 such that button 520 moves independent of or relative to the member 525. The member 525 can couple the turn-signal sub-assembly 320 with the throttle housing 403. For example, as shown in FIG. 5A, the member 525 includes at least one end or endpoint (shown as end 530) that is integrated with or otherwise coupled with an internal portion of the throttle sub-assembly 305. As another example, the end 530 can be attached or otherwise secured to receiver 415. The member 525 can fixably couple the turn-signal sub-assembly 320 with a stationary element (e.g., the receiver 415) of the throttle sub-assembly 305 such that a position of the turn-signal sub-assembly 320 is maintained even as one or more of the throttle housing 403 or a housing of the toggle sub-assembly 310 move.

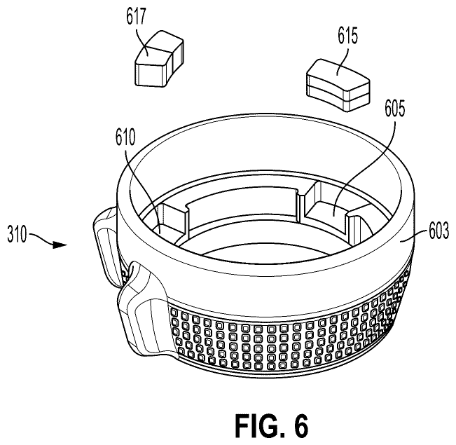

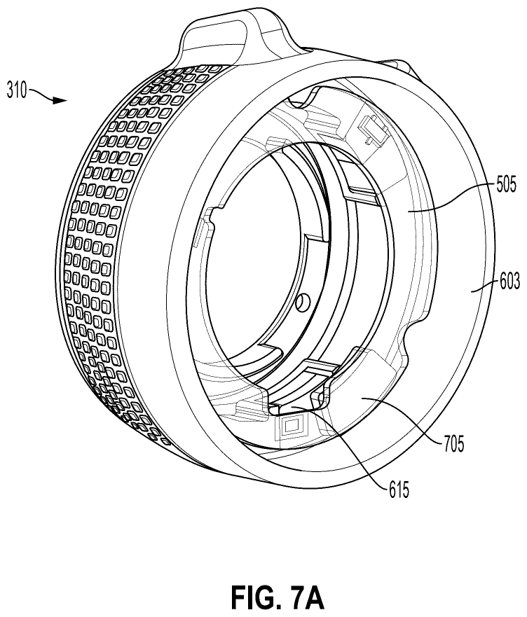

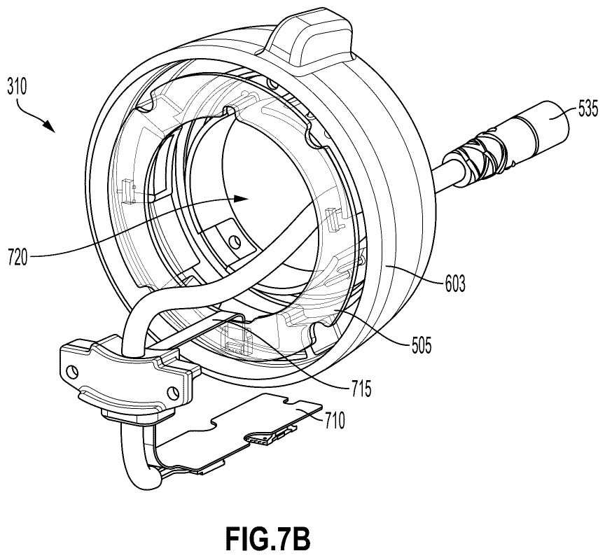

FIG. 6, FIG. 7A, and FIG. 7B depict perspective views of the toggle sub-assembly 310, in accordance with some aspects. For example, the perspective views (of the toggle sub-assembly 310) can refer to or represent a view of the toggle sub-assembly 310 separated from or otherwise decoupled from the throttle sub-assembly 305. The toggle sub-assembly 310 can include at least one second housing (shown as toggle housing 603). The toggle housing 603 can couple with one or more components of the assembly 200. For example, the toggle housing 603 can movably couple with the throttle housing 403. The toggle housing 603 can move or otherwise rotate independent from or relative to the throttle housing 403. For example, the toggle housing 603 can move while the position or placement of the throttle housing 403 is maintained. As another example, the toggle housing 603 can rotate, about the axis 510, separate from or independent of the throttle housing 403. The toggle housing 603 can refer to or include a second element that is rotatably coupled with a portion of the assembly 200, such as the housing of the assembly 200.

The toggle housing 603 can receive at least one input. For example, the toggle housing 603 can receive one or more inputs to indicate an amount of assistance to provide while the rider of the bike 100 is manually (e.g., pedaling) propelling the bike 100. The amount of assistance can refer to or include an output provided by the drive mechanism 155 to assist in powering or otherwise moving the drivetrain 170. For example, the amount of assistance represents how much effort or power the operator of the bike 100 provides in order to propel or move the bike 100. The toggle housing 603 can receive the inputs responsive to one or more movements. For example, the toggle housing 603 can rotate or otherwise move in first direction to receive the inputs.

The inputs can be received responsive to activation or actuation of the toggle housing 603. For example, the toggle housing 603 can receive the inputs responsive to an operator moving, activating, or otherwise actuating the toggle housing 603 to move the toggle housing 603 in a first direction. As another example, the toggle housing 603 can receive the inputs responsive to the toggle housing 603 having moved about the axis 510. The toggle housing 603 can move between one or more positions. For example, the toggle housing 603 can rotate about the axis 510 to move from a first position (similar to that shown in FIG. 3) to a second position. The receipt of the inputs (e.g., movement of the toggle housing 603) can trigger the generation of one or more control signals. For example, a processing circuit or circuitry (of the assembly 200 or the bike 100) can generate or transmit one or more control signals to control a characteristic of the bike 100, such as an amount of assistance provided by the drive mechanism 155.

The toggle housing 603 can return to at least one position. For example, responsive to deactivation or a release of the toggle housing 603, the toggle housing 603 can return to the position shown in FIG. 3. The toggle housing 603 can be biased (e.g., spring loaded) or arranged such that, upon deactivation or release of the toggle housing 603, the toggle housing 603 returns to a default position. For example, the toggle housing 603 can return to a default or resting position without a subsequent activation of the toggle housing 603 by the rider of the bike 100.

The toggle housing 603 can include at least one recess. For example, as shown in FIG. 6, the toggle housing 603 includes a second recess 605 and a third recess 610. The recesses (e.g., the second recess 605, the third recess 610, etc.) of the toggle housing 603 can provide an indent, a cavity, or segment for which at least one magnet can be placed. For example, as shown in FIG. 6, the second recess 605 is arranged to receive a second magnet 615. As another example, as shown in FIG. 6, the third recess 610 is arranged to receive a third magnet 617.

The toggle housing 603 can define at least one detent. For example, as shown in FIG. 7A, the second magnet 615 can define a stoppage point or rest point with respect to an amount of rotation for the toggle housing 603. The second magnet 615 can interact with or otherwise abut a fourth magnet 705 (shown as being disposed on the circuit board 505 in FIG. 7A) to define the detent. For example, responsive to a movement of the toggle housing 603, the second magnet 615 can move towards or otherwise approach the fourth magnet 705. Once the second magnet 615 is within a given distance of the fourth magnet 705, the second magnet 615 and the fourth magnet 705 can experience magnet attraction or magnetic adhesion such that movement of the toggle housing 603 is slowed or otherwise altered. The slowing of the toggle housing 603 can result in a perception (by the rider) of the detent. For example, the second magnet 615 interacting with (responsive to a movement of the toggle housing 603) the fourth magnet 705 can define an incremental position or locking of the toggle housing 603.

As shown in FIG. 7B, the assembly 200 can include at least one second circuit board (shown as second circuit board 710). The second circuit board 710 can house or otherwise include one or more elements that interface with the turn-signal sub-assembly 320. For example, the second circuit board 710 can house a tactile button that is actuated or compressed based on an interaction with the turn-signal sub-assembly 320 or a button thereof. The second circuit board 710 can be electrically coupled with the circuit board 505. For example, cabling 715 can electrically couple the second circuit board 710 with the circuit board 505, such that information, data, or signals can be exchanged between the second circuit board 710 and the circuit board 505. The cabling 715 can refer to or include flex cable that can span from the circuit board 505 to the second circuit board 710. The second circuit board 710 can be electrically coupled with the cabling 535. The cabling 535 can be indirectly, electrically coupled with the circuit board 505 via the second circuit board 710.

The toggle sub-assembly 310 can define, establish, or otherwise include at least one cavity, opening, or void for which one or more components of the assembly 200 or the bike 100 can traverse. For example, as shown in FIG. 7B, the toggle sub-assembly 310 can include at least one cavity (shown as first cavity 720). The first cavity 720 can be defined by a cut-out or circular hole within the center or center portion of the toggle housing 603. The elongated member 325 can traverse or otherwise pass through the first cavity 720.

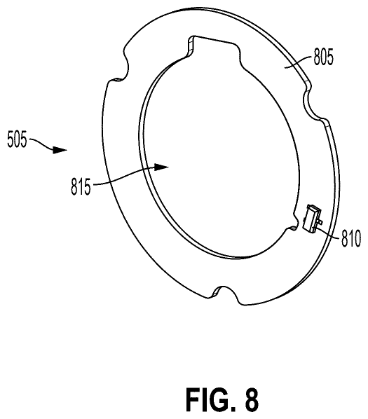

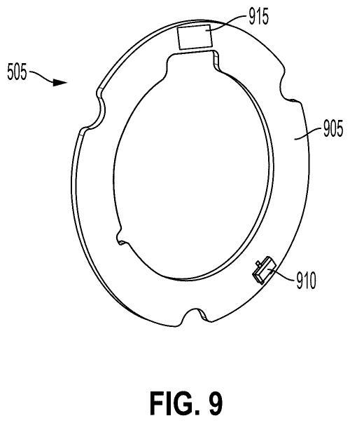

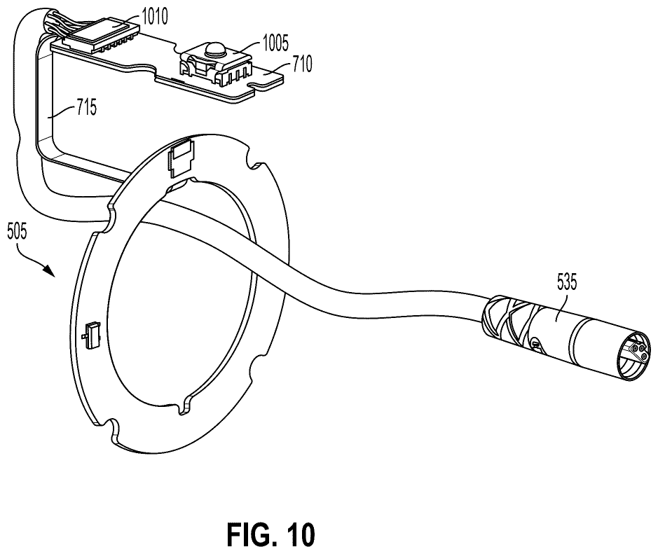

FIG. 8, FIG. 9, and FIG. 10 depict perspective views of respective sides of the circuit board 505, in accordance with some aspects. For example, as shown in FIG. 8, the circuit board 505 includes a first side 805. The first side 805 can abut or be located proximate to at least one component of the assembly 200. For example, the first side 805 can contact or otherwise rest on a surface of the receiver 415. As another example, the first side 805 can be located within the throttle housing 403. The circuit board 505 can include at least one shape or design. For example, as shown in FIG. 8, the circuit board 505 includes a circular shape with a cut-out, hole, or cavity (shown as second cavity 815) at the center or central region of the circuit board 505. The second cavity 815 can define an opening or a void for which one or more components of the assembly 200 or the bike 100 can traverse through. For example, the elongated member 325 can traverse through the second cavity 815.

The first side 805 can receive or otherwise accept one or more components of the assembly 200. For example, as shown in FIG. 8, the first side 805 can receive at least one first sensor 810. The first sensor 810 can be coupled with or otherwise secured to the first side 805 such that the position or location of the first sensor 810 is fixed or otherwise maintained. For example, the position of the first sensor 810 can be maintained even as the throttle housing 403 or the toggle housing 603 move.

The first sensor 810 can refer to or include at least one of Hall Effect sensors, Anisotropic Magnetoresistance (AMR) sensors, among other possible types of sensors that can detect magnets or magnetic fields. The first sensor 810 can refer to or include one or more of optical encoders, potentiometers, accelerometers, gyroscopes, contact switches, or other sensors or switches that can detect movement. The first sensor 810 can detect or monitor movement or positions of one or more components of the assembly 200. For example, the first sensor 810 can monitor movement of the throttle housing 403 by tracking a strength of a magnetic field provided by the first magnet 410. For example, as the throttle housing 403 moves (from the position shown in FIG. 3) to a second position, the strength of the magnetic field (of the first magnet 410) can increase as the first magnet moves towards or otherwise approaches the first sensor 810. As the first magnet 410 moves away from the first sensor 810, the magnetic field can decrease.

As shown in FIG. 9, the circuit board 505 includes a second side 905. The second side 905 can receive one or more components of the assembly 200. For example, as shown in FIG. 9, the second side 905 can receive at least one second sensor 910 and at least one processing circuit 915. At least one of the second sensor 910 or the processing circuit 915 can be coupled with or otherwise secured to the second side 905. For example, the second sensor 910 can be secured to one or more portions of the second side 905 such that a position (within space) of the second sensor 910 is maintained.

The second side 905 can electrically couple the processing circuit 915 with one or more components. For example, the processing circuit 915 can be electrically coupled, via the second side 905, with the drive mechanism 155. As another example, the second side 905 can electrically couple processing circuit 915 with the battery pack 105. The second sensor 910 can include similar hardware or perform similar functionality to that of the first sensor 810. For example, the second sensor 910 can detect a strength of a magnetic field provided by at least one of the second magnet 615 or the third magnet 617. The second sensor 910 can monitor a position or changes in the position of at least one component of the assembly 200 by tracking changes in a magnetic field. For example, the second sensor 910 can detect at least one movement of the toggle housing 603 based on a magnetic field (brought about by the third magnet 617) having changed (e.g., increased, decreased). The magnetic field of the third magnet 617 can increase as a result of movement in the toggle housing 603 as a relative distance between the third magnet 617 and the second sensor 910 decreases as the toggle housing 603 moves about the axis 510.

The processing circuit 915 can include at least one hardware device, processing device, computing device, or circuitry described herein. For example, processing circuit 915 can include one or more processors coupled with memory. The one or more processors, coupled with memory, can execute, implement, perform, or otherwise facilitate one or more steps, processes, functions, or methods described herein. For example, the one or more processors (e.g., the processing circuit 915) can facilitate the control of the drive mechanism 155. The processing circuit 915 can receive one or more signals. For example, the processing circuit 915 can receive data transmissions (e.g., signals) from at least one of the first sensor 810 or the second sensor 910. As another example, the processing circuit 915 can receive signals from one or more components of the bike 100.

The processing circuit 915 can receive information that corresponds to or indicates a position of one or more components of the assembly 200. For example, the processing circuit 915 can receive first information, from the first sensor 810, that provides an indication of a position or a change in position of the throttle housing 403. As another example, the processing circuit 915 can receive second information, from the second sensor 910, that provides an indication of a position or a change in position of the toggle housing 603.

The information (provided by the first sensor 810 or the second sensor 910) can be with respect to one or more magnets of the assembly 200. For example, the first information can represent a change in a position of the first magnet 410. The processing circuit 915 can interpret or relate the change in position of the first magnet 410 to a corresponding change in position of the throttle housing 403. For example, if the first sensor 810 detects a rotation of 15 degrees, the processing circuit 915 can determine (given that the first magnet 410 and the throttle housing 403 move in coordination or synchronously) that the throttle housing 403 has also moved by 15 degrees.

The processing circuit 915 can detect one or more inputs based on the information received from the first sensor 810 or the second sensor 910. For example, the processing circuit 915 can detect receipt of one or more inputs (by the throttle housing 403) based on information (provided by the first sensor 810) indicating a movement or activation of the throttle housing 403. As another example, the processing circuit 915 can determine that the throttle housing 403 received one or more inputs to control a speed of the bike 100. As another example, the processing circuit 915 can detect receipt of one or more inputs (by the toggle housing 603) based on information provided by the second sensor 910. The information, from the second sensor 910, can indicate a movement of the third magnet 617 which suggests a subsequent or corresponding movement in the toggle housing 603.

The processing circuit 915 can produce, forward, or otherwise transmit one or more signals to control subsequent operation of the bike 100. For example, the processing circuit 915 can transmit, via the cabling 535, one or more signals to the drive mechanism 155 to cause the drive mechanism 155 to produce an output (e.g., mechanical power, torque, etc.) to power, propel, or otherwise move the drivetrain 170. As another example, the processing circuit 915 can transmit, via the cabling 535, one or more signals (to a rotational element of the pedals 160) to assist the operator of the bike 100 in rotating or otherwise moving the pedals 160.

As shown in FIG. 10, the second circuit board 710 houses at least one input element (shown as tactile button 1005) and at least one connector (shown as connector 1010). The tactile button 1005 can be depressed, compressed, or otherwise actuated (by a button or other input element of the turn-signal sub-assembly 320) to trigger one or more actions. For example, compression of the tactile button 1005 can cause the lights 125 (or turn signal) to turn on or off. The connector 1010 can electrically couple the second circuit board 710 and the circuit board 505 with the cabling 535.

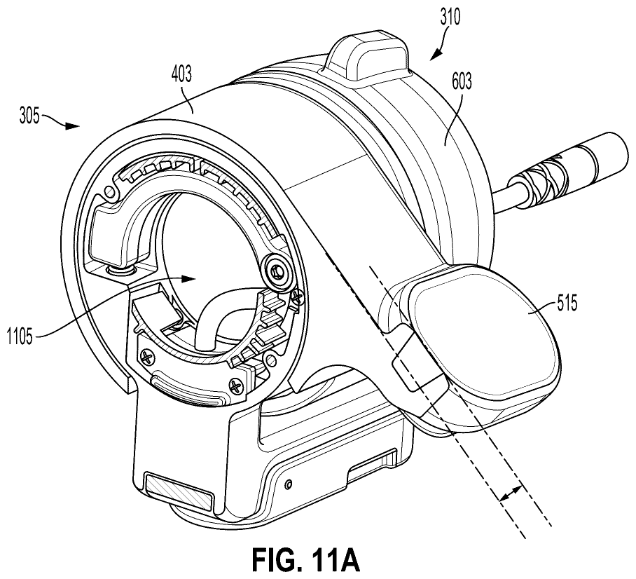

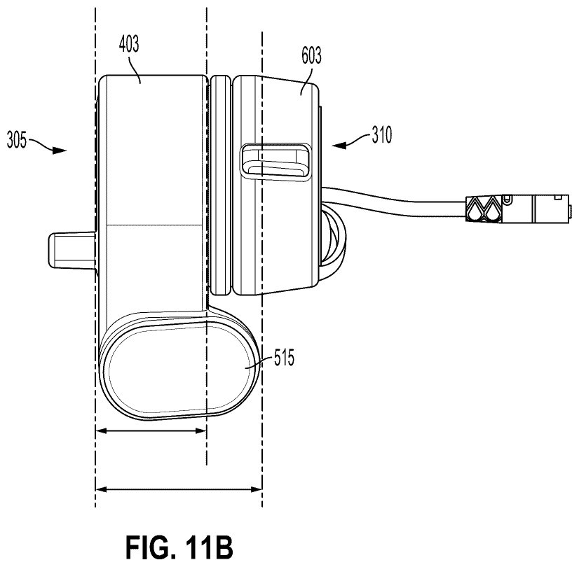

FIG. 11A and FIG. 11B depict perspective views of the throttle sub-assembly 305 and the toggle sub-assembly 310, according to some aspects. The perspective views can refer to or include a view of the throttle sub-assembly 305 movably coupled with the toggle sub-assembly 310. For example, FIG. 11A or FIG. 11B depict example views of the throttle sub-assembly 305 secured with the toggle sub-assembly 310. The throttle sub-assembly 305 can include at least one aperture, opening, void, or cavity. For example, as shown in FIG. 11A, the throttle sub-assembly 305 includes at least one cavity (shown as third cavity 1105). The third cavity 1105 can provide an opening or a void for which a component or element of the assembly 200 or the bike 100 can traverse through. For example, the elongated member 325 can traverse the third cavity 1105.

As shown in FIG. 11A, two dashed lines have been added to illustrate that the thumb pad 515 is raised or otherwise elevated relative to the throttle housing 403. For example, the thumb pad 515 can include a vertical height or dimension such that the thumb pad 515 is elevated above the throttle housing 403. As another example, the thumb pad 515 can be raised or extend higher than the throttle housing 403.

As shown in FIG. 11B, three dashed lines have been added to illustrate respective lateral dimensions for the throttle housing 403 and the thumb pad 515. For example, the dimension between the leftmost dashed line and the dashed line (situated between the leftmost dashed line and the rightmost dashed line) can represent or illustrate a lateral dimension for the throttle housing 403. As another example, the dimension between the leftmost dashed line and the rightmost dashed line can represent a lateral dimension for the thumb pad 515. The lateral dimension of the thumb pad 515 can be larger than the lateral dimension of the throttle housing 403.

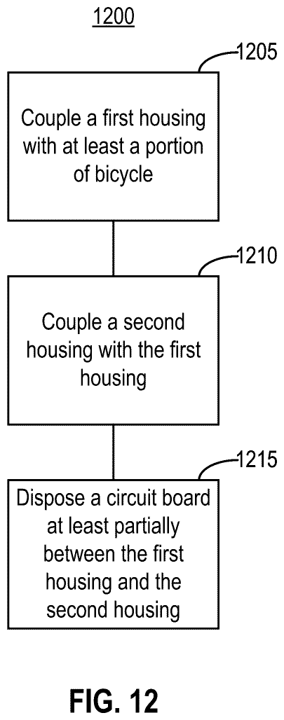

FIG. 12 is a flow diagram of a process 1200 to manufacture at least one assembly, in accordance with some aspects. The process 1200 can refer to or include the manufacturing of at least one assembly described herein. For example, the process 1200 can include manufacturing of the assembly 200. As another example, the process 1200 can include manufacturing or assembling the throttle sub-assembly 305. The process 1200 or one or more acts thereof can be repeated, replicated, omitted, reproduced, skipped, modified, separated, combined, or otherwise changed.

At act 1205, a first housing can be coupled with at least a portion of a bicycle. For example, the throttle housing 403 can be coupled with at least a portion of the handle 203. The throttle housing 403 can be coupled with the handle 203 by at least one of securing, attaching, mounting, or otherwise connecting the throttle housing 403 to the handle 203. The first housing can receive at least one input. For example, the first housing can receive, responsive to a rotation or movement of the first housing, one or more first inputs to control a rate of speed of the bicycle. As another example, the first housing can receive one or more inputs to indicate an output of a drive mechanism of the bicycle.

At act 1210, a second housing can be coupled with the first housing. For example, the toggle housing 603 can be coupled with the throttle housing 403. The toggle housing 603 can be coupled with the throttle housing 403 by at least one of securing, attaching, mounting, or otherwise connecting the toggle housing 603 to the throttle housing 403. The second housing can receive at least one input. For example, the second housing can receive, responsive to rotation or movement of the second housing, one or more second inputs to indicate an amount of assistance provided by a drive mechanism.

At act 1215, a circuit board can be disposed at least partially between the first housing and the second housing. For example, the circuit board 505 can be located or positioned between the toggle housing 603 and the throttle housing 403 responsive to the toggle housing 603 and the throttle housing 403 having been coupled to one another. The circuit board can be disposed between the first housing and the second housing by at least one of placing, positioning, locating, or otherwise situating the circuit board between the first housing and the second housing. The circuit board can include at least one sensor to detect movement of the first housing or movement of the second housing.

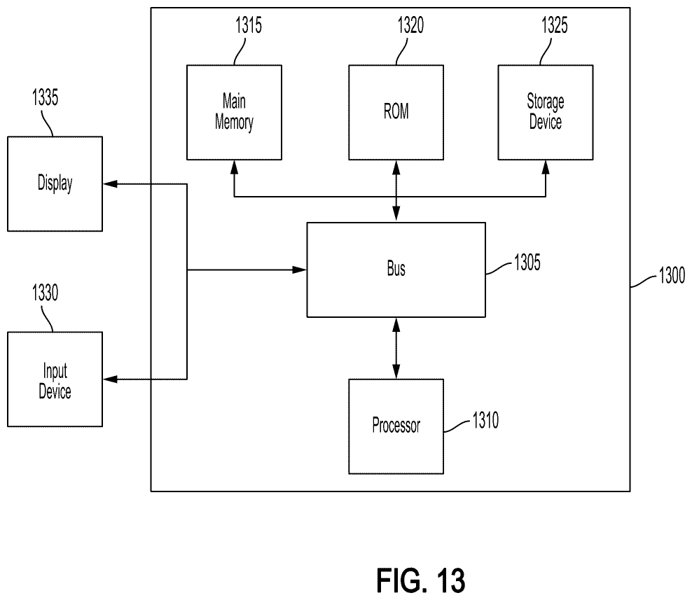

FIG. 13 depicts an example block diagram of an example computer system 1300. The computer system 1300 can include or be used to implement a data processing system or its components. The computer system 1300 includes at least one bus 1305 or other communication component for communicating information. The computer system 1300 can include one or more processors (shown as processor 1310) or processing circuits coupled to the bus 1305 for processing information. The computer system 1300 also includes at least one main memory 1315, such as a random access memory (RAM) or other dynamic storage device, coupled to the bus 1305 for storing information, and instructions to be executed by the processor 1310. The main memory 1315 can be used for storing information during execution of instructions by the processor 1310. The computer system 1300 may further include at least one read only memory (shown as ROM 1320) or other static storage device coupled to the bus 1305 for storing static information and instructions for the processor 1310. A storage device 1325, such as a solid state device, magnetic disk or optical disk, can be coupled to the bus 1305 to persistently store information and instructions.

The computer system 1300 may be coupled via the bus 1305 to a display 1335, such as a liquid crystal display, or active matrix display, for displaying information to an operator of the bike 100. An input device 1330, such as a keyboard or voice interface may be coupled to the bus 1305 for communicating information and commands to the processor 1310. The input device 1330 can include a touch screen display (e.g., the display 1335). The input device 1330 can also include a cursor control, such as a mouse, a trackball, or cursor direction keys, for communicating direction information and command selections to the processor 1310 and for controlling cursor movement on the display 1335.

The processes, systems and methods described herein can be implemented by the computer system 1300 in response to the processor 1310 executing an arrangement of instructions contained in main memory 1315. Such instructions can be read into main memory 1315 from another computer-readable medium, such as the storage device 1325. Execution of the arrangement of instructions contained in main memory 1315 causes the computer system 1300 to perform the illustrative processes described herein. One or more processors in a multi-processing arrangement may also be employed to execute the instructions contained in main memory 1315. Hard-wired circuitry can be used in place of or in combination with software instructions together with the systems and methods described herein. Systems and methods described herein are not limited to any specific combination of hardware circuitry and software.

Although an example computing system has been described in FIG. 13, the subject matter including the operations described in this specification can be implemented in other types of digital electronic circuitry, or in computer software, firmware, or hardware, including the structures disclosed in this specification and their structural equivalents, or in combinations of one or more of them.

The micromobility device (referred to herein as bike 100) can be or include at least one drive unit (e.g., a propulsion system), at least one wheel, at least one battery pack, and a frame. The drive unit, the wheel, and the battery pack can be coupled with the frame. The drive unit can rotate the wheel to propel the micromobility device. The micromobility device can include the battery pack to power the drive unit and rotate the wheel with or without application of a mechanical force to a pedal assembly by the user. For example, the micromobility device can be propelled by a mechanical force provided by the user to the pedal assembly, by an electrical force provided by a battery pack to a motor, or some combination thereof. The micromobility device can include single rider bicycles, tandem bicycles, cargo bicycles, motor-assist bicycles, pedicabs, electric-assist bicycles, road bicycles, mountain bicycles, electric scooters, electric skateboards, standing devices, or unicycles, or devices with one, two, three, four or more than four wheels.

In various embodiments, a micromobility device (which may be or include the bike 100) can be designed to support a gross vehicle weight, defined as the combined mass of the device, rider, payload, and accessories, which corresponds to applicable regulatory or industry standards for micromobility devices. By way of example and without limitation, certain bicycle-based and electric bicycle standards, such as ISO 4210 and EN 15194, contemplate testing and design assumptions for a total mass on the order of approximately 120 kilograms, inclusive of rider and load, while other micromobility categories, including scooters, mopeds, and cargo-oriented devices, may be designed for higher gross vehicle weights, such as greater than 120 kilograms, greater than 150 kilograms, or greater than 200 kilograms, depending on jurisdiction, classification, and intended use. In some embodiments, the micromobility device may be configured to comply with regulations and testing protocols, such as those administered by the U.S. Consumer Product Safety Commission, which may specify structural strength, braking performance, and fatigue testing criteria corresponding to representative rider and payload masses. References to such weight values are intended to reflect regulatory examples rather than to impose fixed design limits on the disclosed embodiments.

The propulsion system may include an electric motor, a human-powered drivetrain, or a combination thereof, and may be configured in hub-based, mid-mounted, or remote arrangements using chain, belt, shaft, gear, friction, or direct-drive mechanisms to transmit torque to at least one ground-engaging element. An energy storage system may be provided to store electrical energy for powering the propulsion system and auxiliary components, and may include one or more batteries, capacitors, fuel cells, or other energy storage technologies that may be removable, fixed, swappable, or distributed across multiple locations on the device. The energy storage system may further include charging circuitry, battery management systems, thermal management components, and monitoring elements configured to meet or exceed applicable electrical standards for micromobility devices, including but not limited to UL 2849, UL 2272, IEC 62133, or equivalent regional or international standards.

The micromobility device may further include a control system comprising one or more processors, controllers, sensors, and communication interfaces configured to manage propulsion output, braking behavior, energy usage, and auxiliary functions. The control system may regulate motor output based on rider input, operating conditions, load, speed, inclination, or environmental sensing, and may support software-based features such as diagnostics, data logging, fleet management integration, geofencing, or over-the-air software updates. Braking systems may include mechanical, hydraulic, electromagnetic, regenerative, or combined braking mechanisms, and the device may further include stability or features such as traction control, anti-lock braking, suspension systems, steering dampening elements, lighting systems, and audible warning devices. In various embodiments, the micromobility device may be designed to comply with applicable operational and mechanical standards, including but not limited to ISO 4210, EN 15194, SAE J3194, applicable portions of 16 CFR Part 1512, and corresponding regional, national, or municipal micromobility regulations governing speed, power output, braking performance, lighting, and gross vehicle weight classifications.

The micromobility device may include a rider interface configured to receive user input through handlebars, grips, pedals, throttles, buttons, touch interfaces, or gesture-based controls, and may alternatively or additionally include a payload interface configured to support cargo, delivery containers, child seats, or autonomous payload modules. In some embodiments, the micromobility device may be configured as, or convertible between, multiple micromobility form factors, including electric bicycles, scooters, mopeds, seated or standing ride-on devices, or cargo and utility vehicles, wherein such configurations may share common components or differ only in selected structural, propulsion, control, or interface elements. Unless otherwise stated, the components and features described herein may be combined, omitted, rearranged, scaled, or substituted without departing from the scope of the disclosure, and references to regulatory standards or weight limits are intended to be exemplary and non-limiting.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device,” “component,” “data processing apparatus,” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements, and features discussed in connection with one implementation are not intended to be excluded from a similar role in other implementations or implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment disclosed herein, and references to “an implementation,” “some implementations,” “one implementation,” or the like are not necessarily mutually exclusive and are intended to indicate that a particular feature, structure, or characteristic described in connection with the implementation may be included in at least one implementation or embodiment. Such terms, as used herein, are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A,’ only ‘B,’ as well as both ‘A’ and ‘B.’ Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes, and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical, or other positioning or orientation descriptions include variations within +/−10% or +/−10 degrees of pure vertical, parallel, or perpendicular positioning. References to “approximately,” “substantially,” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A micromobility device, comprising:
a frame configured to support the micromobility device; and
an assembly, including:
a housing configured to couple with the frame;
a first element rotatably coupled with the housing;
a second element rotatably coupled with the housing;
a circuit board disposed at least partially between the first element and the second element;
the circuit board including a first sensor configured to detect rotation of the first element and a second sensor configured to detect rotation of the second element; and
the circuit board configured to output, based at least on detection of the rotation of the first element or the rotation of the second element, a control signal to control a characteristic of the micromobility device.

2. The micromobility device of claim 1, comprising:
the first element including a first housing configured to receive a first input, during the rotation of the first element, to control a rate of speed of the micromobility device; and
the second element including a second housing configured to receive a second input, during the rotation of the second element, to indicate an amount of assistance provided by a drive mechanism of the micromobility device.

3. The micromobility device of claim 1, comprising:
the first element defining a first cavity;
the second element defining a second cavity; and
a handle including an elongated member, wherein the first cavity and the second cavity are configured to encircle the elongated member.

4. The micromobility device of claim 1, comprising:
a handle including an elongated member;
wherein:
the circuit board is disposed internal to each of the first element and the second element; and
the circuit board defines a cavity to accept the elongated member.

5. The micromobility device of claim 1, comprising:
the first element including at least one first recess to receive a first magnet;
the second element including at least one second recess to receive a second magnet; and
the circuit board including:
a first side, wherein the first sensor is disposed on the first side, the first sensor configured to monitor a position of the first magnet; and
a second side, wherein the second sensor is disposed on the second side, the second sensor configured to monitor a position of the second magnet.

6. The micromobility device of claim 1, comprising:
the first element configured to:
move, responsive to a first actuation, in a first direction about an axis; and
move, responsive to a second actuation, in a second direction opposite the first direction.

7. The micromobility device of claim 1, comprising:
the second element configured to:
move, responsive to an actuation, from a first position to a second position; and
return, responsive to a deactivation, to the first position.

8. The micromobility device of claim 1, comprising:
a movable member integrated with the first element;
the movable member configured to receive a force to move the first element;
the movable member raised relative to the first element; and
a lateral dimension of the movable member larger than a lateral dimension of the first element.

9. The micromobility device of claim 1, comprising:
at least one cable configured to electrically couple the circuit board with one or more components of the micromobility device; and
the at least one cable configured to traverse through each of a first cavity defined by the first element, a second cavity defined by the circuit board, and a third cavity defined by the second element to electrically couple the circuit board with the one or more components.

10. The micromobility device of claim 1, wherein the characteristic is at least one of a rate of speed of the micromobility device or an amount of assistance provided by a drive mechanism of the micromobility device.

11. An assembly, comprising:
a first housing coupled with a frame of a micromobility device;
the first housing to receive one or more first inputs to control a rate of speed of the micromobility device;
a second housing coupled with the first housing;
the second housing to receive one or more second inputs to indicate an amount of assistance provided by a drive mechanism of the micromobility device;
a circuit board to dispose at least partially between the first housing and the second housing; and
the circuit board including at least one sensor to detect movement of the first housing and movement of the second housing.

12. The assembly of claim 11, comprising:
the first housing defining a first cavity disposed internal to the first housing;
the second housing defining a second cavity disposed internal to the second housing; and
a handle including an elongated member to traverse through each of the first cavity and the second cavity to couple the first housing and the second housing with the frame.

13. The assembly of claim 11, comprising:
the circuit board disposed internal to each of the first housing and the second housing; and
the circuit board including a circular shape to define a cavity to accept an elongated member of a handle of the micromobility device.

14. The assembly of claim 11, comprising:
the first housing including at least one first recess to receive a first magnet;
the second housing including at least one second recess to receive a second magnet; and
the circuit board including:
a first side to receive a first sensor of the at least one sensor, the first sensor configured to monitor a position of the first magnet; and
a second side to receive a second sensor of the at least one sensor, the second sensor configured to monitor a position of the second magnet.

15. The assembly of claim 11, comprising:
the circuit board including one or more processors, coupled with memory, to:
receive, from the at least one sensor, first information which corresponds to a first position of at least one first magnet disposed within the first housing or second information which corresponds to a second position of at least one second magnet disposed within the second housing;
detect, based on the first information or the second information, the one or more first inputs or the one or more second inputs; and
control subsequent operation of the micromobility device based at least on the one or more first inputs or the one or more second inputs.

16. The assembly of claim 11, comprising:
the first housing configured to:
move, responsive to a first actuation, in a first direction about an axis; and
move, responsive to a first deactivation, in a second direction opposite the first direction; and
the second housing configured to:
define, via at least one magnet, one or more detents to define an amount of rotation to receive the one or more second inputs.

17. The assembly of claim 11, comprising:
the second housing configured to:
move, responsive to an actuation, from a first position to a second position; and
return, responsive to a deactivation, to the first position.

18. A system, comprising:
an assembly, including:
a first housing coupled with a frame of a micromobility device;
the first housing configured to receive one or more first inputs to control a rate of speed of the micromobility device;
a second housing coupled with the first housing;
the second housing configured to receive one or more second inputs to indicate an amount of assistance provided by a drive mechanism of the micromobility device;
a circuit board to dispose at least partially between the first housing and the second housing; and
the circuit board including at least one sensor to detect movement of the first housing and movement of the second housing.

19. The system of claim 18, comprising:
the first housing defining a first cavity disposed internal to the first housing;
the second housing defining a second cavity disposed internal to the second housing; and
a handle including an elongated member to traverse through each of the first cavity and the second cavity to couple the first housing and the second housing with the frame.

20. The system of claim 18, comprising:
the circuit board disposed internal to each of the first housing and the second housing; and
the circuit board including a circular shape to define a cavity to accept an elongated member of a handle of the micromobility device.
